(19) United States
(12) Patent Application Publication
(10) Pub. No.: US 2007/0050198 A1
(43) Pub. Date: Mar. 1, 2007

(54) Systems and methods for improving product development processes

(76) Inventors: Randall D. Ledford, St. Louis, MO (US); Gautam Sinha, St. Louis, MO (US); Mark Bulanda, Chesterfield, MO (US); Eric Carlson, Creve Coeur, MO (US)

Correspondence Address: HARNESS, DICKEY & PIERCE, P.L.C., P.O. BOX 828, BLOOMFIELD HILLS, MI, 48303, US

(21) Appl. No.: 11/418,550

(22) Filed: May 4, 2006

Related U.S. Application Data
(60) Provisional application No. 60/678,953, filed on May 5, 2005.

(51) Int. Cl. G06Q 99/00

(52) U.S. Cl. 705/1

(57) ABSTRACT

A method for developing products for a company comprises dividing a product development process into a plurality of project phases; for each of the plurality of project phases, defining deliverables by functional groups within the company; specifying a plurality of project gates between at least two pairs of adjacent phases; defining a plurality of key initiatives of the company; for each of the key initiatives, defining at least one of tasks, tools and resources as a function of the project phases that are designed to facilitate achieving the key initiatives; and for each of the project gates, defining gate decisions to be made before proceeding to a subsequent phase.

### CROSS-REFERENCE TO RELATED APPLICATIONS

This application claims the benefit of U.S. Provisional Application No. 60/678,953, filed on May 5, 2005. The disclosure of the above application is incorporated herein by reference.

### FIELD OF THE INVENTION

The present invention relates to systems and methods for improving product development processes.

### BACKGROUND OF THE INVENTION

Generating new product sales has become challenging in today's competitive business environment, particularly for companies in mature markets. There is increased pressure to reduce product development time and cost. There is also a desire to leverage a company's expertise into new markets.

Many new product offerings are not based on real product needs of a relevant market. As a result, the new product offering may have lower sales and/or margins than anticipated. Causes may include inadequate market analysis, product design or manufacturing problems, lack of effective marketing, higher costs than anticipated, inadequate competitive analysis, poor timing of introduction, and/or other factors. Cost controls may be put in place too late in the product development process. Product changes may also occur too late in the process and cause significant cost increases. All of these problems can dramatically impact the profitability of the new product.

New product development processes should coordinate the efforts of different functional groups within the organization such as product planning, engineering, manufacturing, marketing, procurement, service, quality, sales and/or finance. These functional groups have different functions at different times in the product planning cycle. It is very difficult to coordinate these different functional groups to ensure that common problems are avoided and company objectives are satisfied.

### SUMMARY OF THE INVENTION

A method for developing products for a company comprises dividing a product development process into a plurality of project phases; specifying a plurality of project gates between at least two pairs of adjacent phases; defining a plurality of key initiatives of the company; for each of the key initiatives, defining at least one of tasks, tools and resources as a function of the project phases that are designed to facilitate achieving the key initiatives; and for each of the project gates, defining gate decisions to be made before proceeding to a subsequent phase.

In other features, defining deliverables by functional groups within the company the method includes for each of the plurality of project phases. The method includes specifying a deliverable definition and identifying at least one of the functional groups to provide input for each of the deliverables. The method includes defining company-defined best practices for each of the deliverables, defining assistance tools for each of the deliverables, and/or assigning gatekeepers to make the gate decisions for each of the project gates. The method includes defining project metrics for each of the project gates and/or providing a visual display showing a relationship between the project phases, the project gates, the key initiatives. The visual display is interactive

In other features, the visual display includes links to project phase descriptions for the project phases, project gate descriptions for the project gates, and key initiative descriptions for the key initiatives. The visual display includes links to descriptions of the at least one of tasks, tools and resources. The links are arranged by the key initiative and the project phases. The method includes implementing the visual display using hyperlinks in a web page. The method includes implementing the visual display using page links in a presentation program. The project gate description includes a gate definition and at least one set of decision criteria. The project phase description includes a phase definition and a key deliverables table arranged by the functional groups. The key deliverables table includes links to at least one deliverable description defining a respective deliverable and additional links to qualitative and quantitative tools and best practices and considerations.

A system and method for improving a product development process in a company comprises a computer including a display and a selecting device. An interactive program that is accessible using the computer, the display and the selecting device visually depicts the product development process divided into project phases, project gates between at least two pairs of adjacent project phases and key initiatives of the company as a function of the project phases.

In other features, the interactive program provides key initiative links to a description of at least one of tasks, tools and resources as a function of the project phases and the key initiatives. The at least one of tasks, tools and resources provide guidelines for achieving the key initiatives at the project phase. The interactive program provides phase links for each of the project phases. The phase links provide descriptions of deliverables by company functional groups. The interactive program provides gate links for each of the project gates. The gate links define gate decisions to be made before proceeding to a subsequent project phase. The interactive program provides a deliverables description including a deliverable definition and identifying at least one of the company functional groups to provide input for each of the deliverables.

In other features, the interactive program provides best practices links to best practices descriptions including company-defined best practices for at least one of the deliverables. The interactive program provides assistance tool links to assistance tools for at least one of the deliverables. The interactive program provides metric links defining project metrics for at least one of the project gates. The interactive program includes a browser, hyperlinks and web pages that are navigated using the links. The interactive program includes a presentation program, a presentation file and page links within the presentation file. The interactive program provides gate links for each of the project gates. The gate links link a user to a corresponding project gate description that includes a gate definition and at least one of set of decision criteria.

In other features, the interactive program provides phase links for each of the project phases. The phase links link a user to a corresponding project phase description that includes a phase definition and a key deliverables table arranged by company functional groups. The key deliverables table includes links to at least one deliverable description defining a respective deliverable and additional links to qualitative and quantitative tools and best practices and considerations.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a flowchart illustrating steps of an exemplary product development method according to the present invention;

FIG. 2 is a functional block diagram of an exemplary interactive product development system according to the present invention;

FIG. 3 illustrates an exemplary interactive product development tool that defines project phases and project gates and integrates them with key company initiatives;

FIG. 4A illustrates exemplary interactive instructions for using the product phases, deliverables, and best practices that are accessible from the product development tool of FIG. 3;

FIG. 4B illustrates exemplary interactive instructions for using the product gates and metrics that are accessible from the product development tool of FIG. 3;

FIG. 4C illustrates exemplary interactive instructions for using the key initiatives and process flows that are accessible from the product development tool of FIG. 3;

FIG. 5 illustrates an exemplary interactive description of project phases and gates;

FIG. 6A illustrates an exemplary interactive description that provides further information relating to a market research project phase including key deliverables organized by company functional groups;

FIG. 6B illustrates an exemplary interactive description of unmet needs of end customers analysis;

FIG. 6C illustrates an exemplary interactive description of qualitative focus groups that can be selected from the unmet needs of end customers analysis of FIG. 6B;

FIG. 6D illustrates an exemplary interactive description of qualitative observational research and other items that can be selected from the unmet needs of end customers analysis of FIG. 6B;

FIG. 6E illustrates an exemplary interactive description relating to quantitative critical incident surveys and other items that can be selected from the unmet needs of end customers analysis of FIG. 6B;

FIG. 6F illustrates a customer driven marketing and pricing high level process flow selectable from the unmet needs of end customers analysis of FIG. 6B;

FIG. 7A illustrates an interactive description of end market area research that is selectable from the customer driven marketing and pricing key initiative in the market research phase of FIG. 3;

FIG. 7B illustrates an interactive description of qualitative group moderators/quantitative questions that is selectable from the customer driven marketing and pricing key initiative in the market research phase of FIG. 3;

FIG. 7C illustrates an interactive description relating to developing participant qualification guidelines/questionnaire that is selectable from the customer driven marketing and pricing key initiative in the market research phase of FIG. 3;

FIG. 7D illustrates an interactive description relating to identifying unmet needs of end customer that is selectable from the customer driven marketing and pricing key initiative in the market research phase of FIG. 3;

FIG. 7E illustrates an interactive description relating to identifying unmet needs of intermediaries and direct customers that is selectable from the customer driven marketing and pricing key initiative in the market research phase of FIG. 3;

FIG. 8A illustrates an interactive description relating to an idea generation phase that describes key deliverables by company functional groups;

FIG. 8B illustrates an interactive description relating to idea proposal deliverables from FIG. 8A;

FIG. 8C illustrates an interactive description relating to project timeline deliverables from FIG. 8A;

FIG. 8D illustrates an interactive description relating to competitive product review deliverables from FIG. 8A;

FIG. 8E illustrates an interactive description relating to competitive end product review deliverables from FIG. 8A;

FIG. 8F illustrates an interactive description relating to product and service innovation concepts deliverables from FIG. 8A;

FIG. 8G illustrates an interactive description relating to brand/category analysis deliverables from FIG. 8A;

FIG. 8H illustrates an interactive description relating to customer analysis deliverables from FIG. 8A;

FIG. 9 illustrates an interactive description relating to a first project gate;

FIG. 10 illustrates an interactive description of a second project gate; and

FIG. 11 illustrates an exemplary metrics description for the second project gate.

### DETAILED DESCRIPTION OF THE PREFERRED EMBODIMENTS

The following description of the preferred embodiment(s) is merely exemplary in nature and is in no way intended to limit the invention, its application, or uses. As used herein, the term link refers to a hyperlink in a web page, a page link in a presentation program or a page reference in a printed document.

An integral part of a company's growth strategy involves increasing new product sales. For example, functional groups within a company may include product planning, engineering, manufacturing, marketing, procurement, service, quality, sales, and/or finance. These functional groups should collaborate continuously throughout the new product development process to successfully introduce new products that have desirable profit margins.

The present invention provides a product development system and method for improving product development processes. The product development system and method defines phases and decision points or project gates of a new product development, integrates key initiatives of the company with the phases, and defines deliverables for each functional group within the company by phase and key initiative. In some implementations, the phases, gates and key initiatives are displayed and related to one another using a single interactive interface or visual display. This product development process will allow a company to address challenges in the marketplace by pursuing the right set of new products, optimizing pricing and revenue opportunities from the new products, leveraging global engineering, minimizing component and manufacturing costs, coordinating development efforts between company functional groups, accelerating time to market, improving management tools to make management more effective during the product development process and leveraging product development tools and technologies.

While the present invention will be described (in some implementations) in conjunction with computer programs, browsers and/or web pages that provide an interactive environment through links or hyperlinks, skilled artisans will appreciate that the present invention may be implemented in a variety of forms. For example, the hyperlinks may be replaced by page numbers in a non-interactive document. Still other embodiments are contemplated in addition to those described herein.

As used herein, the term “project phase” or “phase” refers to a time frame during which cross functional groups within a company execute actions to meet predefined deliverables within a specified time frame. By doing so, decision makers can make informed decisions during project gates. The term “project gate” or “gate” refers to prescheduled meetings at predetermined times that are designed to review progress of a new development project. One purpose of gate meetings is to gain commitment, alignment, and active support from leadership of different company functional groups. During the gate meetings, decisions are preferably based on completed deliverables defined in a preceding phase.

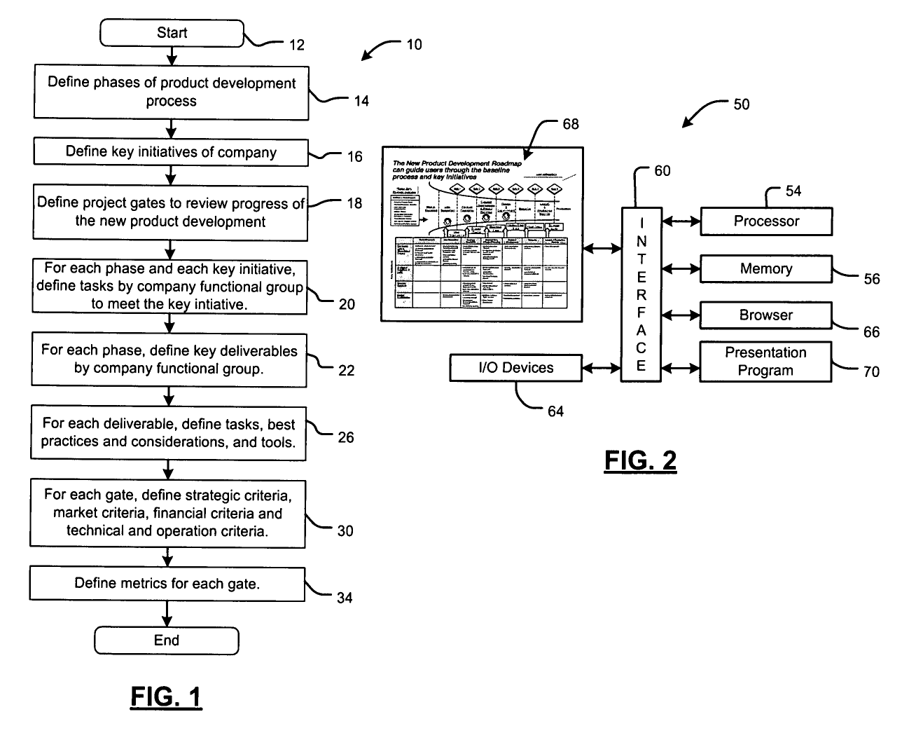

Referring now to FIG. 1, a product development method according to the present invention is shown generally at 10. The method 10 begins at step 12. In step 14, phases of a product development process are defined. For example in an exemplary embodiment described below, the phases include market research, idea generation, concept feasibility, concept development and project planning, design and development, ramp-up, launch and production startup, and/or production, although specific phases will vary for different companies. In step 16, key initiatives of the company are defined. For example, key initiatives may include focus on customer driven marketing and pricing, preferred suppliers and parts, reverse auctions and/or global engineering, although specific key initiatives for a given company will also vary.

In step 18, project gates are defined between adjacent phases to review progress of the new product development. For example, a first or idea submission gate may occur between idea generation and concept feasibility phases. This gate may offer an opportunity to evaluate the need in the marketplace and feasibility based upon a preliminary estimate for the concept in the marketplace.

A second or project charter review gate may occur between concept feasibility and concept development and project planning phases. This gate may relate to assessing commercial and technical feasibility potential return on investment and strategic fit within business objectives as well as a determination relating to the commitment necessary for one or more of the subsequent phases.

A third or business plan review gate may occur between concept development and project planning and design and development phases. This gate relates to assessment of the likelihood of commercial and technical success, potential return on investment and strategic fit with business objectives. Additionally, this gate provides a decision point for authorizing funding and capital investment that will be required for the subsequent phase.

Additional gates may include an update plan and AR review during which management assesses the design, business plan, appropriations request, marketing and sales forecasts, cost estimates, manufacturing capacity, planning estimates to determine whether the funding and capital investment required for the subsequent ramp-up phase are warranted.

A final check gate assesses stability of production processes, remaining risks and readiness and communicates product launch to the field. A process audit gate occurs before production and allows review of production data and initial commercial results against original forecast to determine whether project objectives were met. Improvements to the new product development process may also be solicited. While specific gates are described herein, skilled artisans will appreciate that other gates and timing may be used.

In step 20, tasks are defined by company functional group to meet the key initiatives for each phase and each key initiative. In step 22, key deliverables are defined for each phase by company functional group. In step 26, for each deliverable, tasks, best practices and considerations, tools and/or other goals and considerations to be considered are defined. In step 30, for each gate, decision criteria are defined such as but not limited to strategic criteria, market criteria, financial criteria and/or technical and operational criteria. In step 34, metrics are defined for each gate to facilitate the decision-making process.

Referring now to FIG. 2, in some implementations the product development method may be implemented by a computer 50 that includes a processor 54, memory 56 (such as read-only memory (ROM), random access memory (RAM), flash, external memory such as a hard disk drive or other suitable electronic data storage), an input/output interface 60 (I/O), and I/O devices 64 such as a keyboard, mouse, printer, etc. The computer 50 may include a browser 66 that allows navigation of web pages containing an interactive version of a product development tool 68, which includes page links, page numbers or hyperlinks. Alternately, the computer 50 may execute a presentation program 70 that allows navigation between pages in an interactive version of the product development tool using page links. For example, one suitable presentation program includes Windows® PowerPoint®.

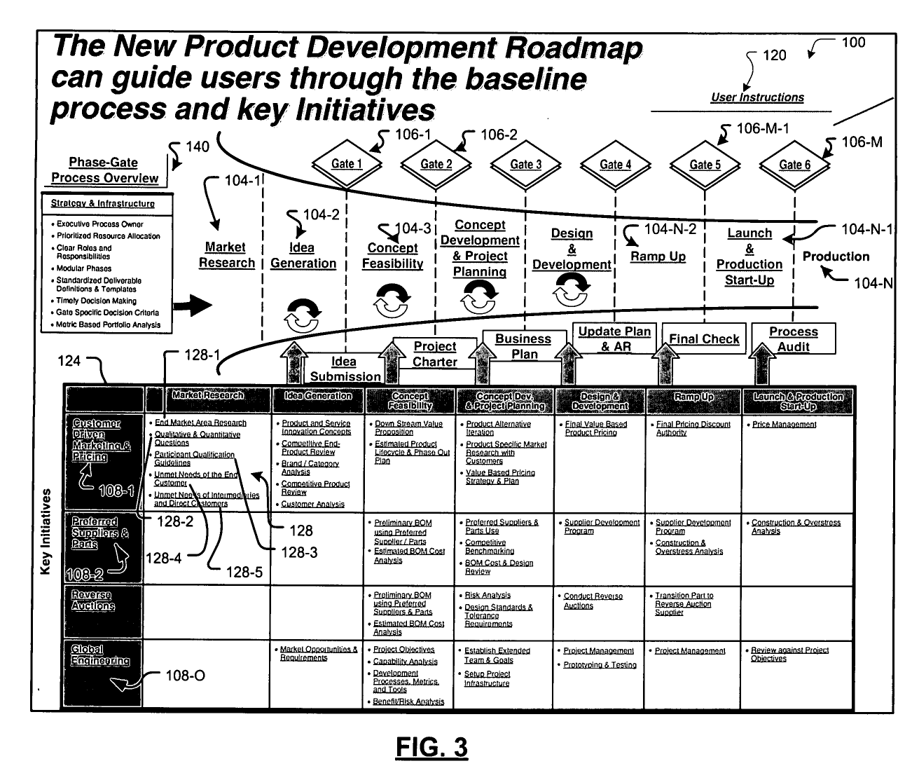

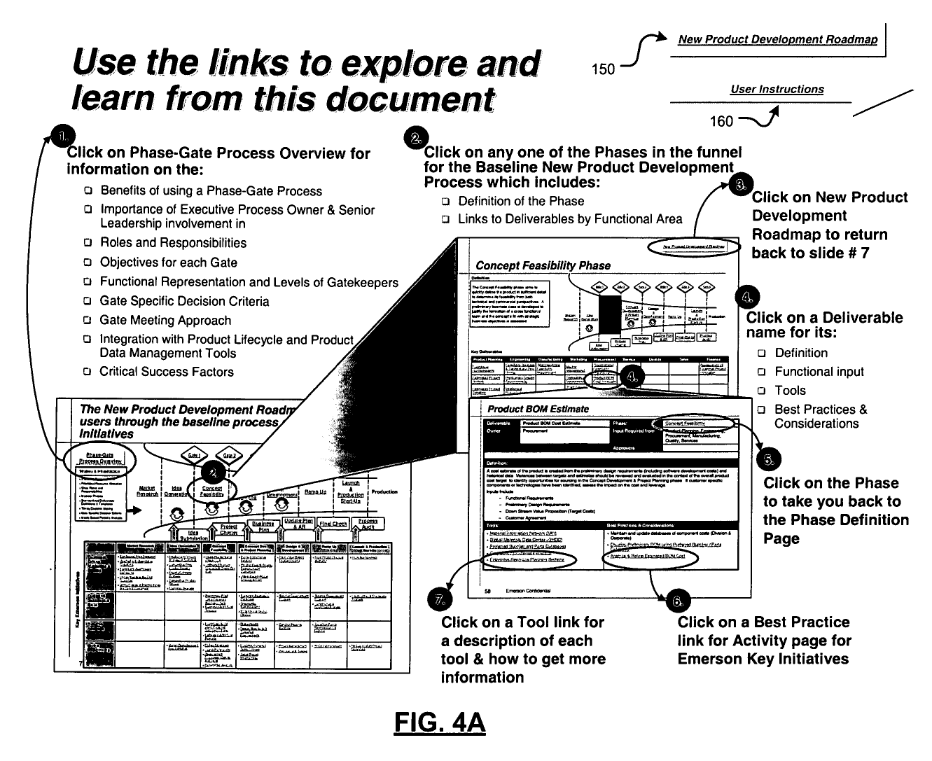

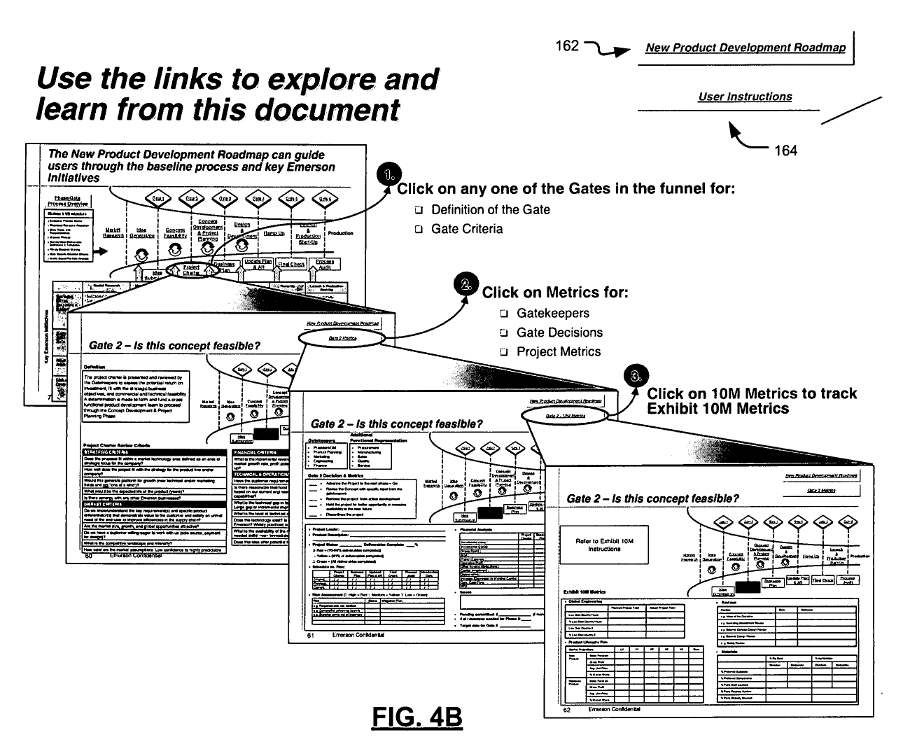

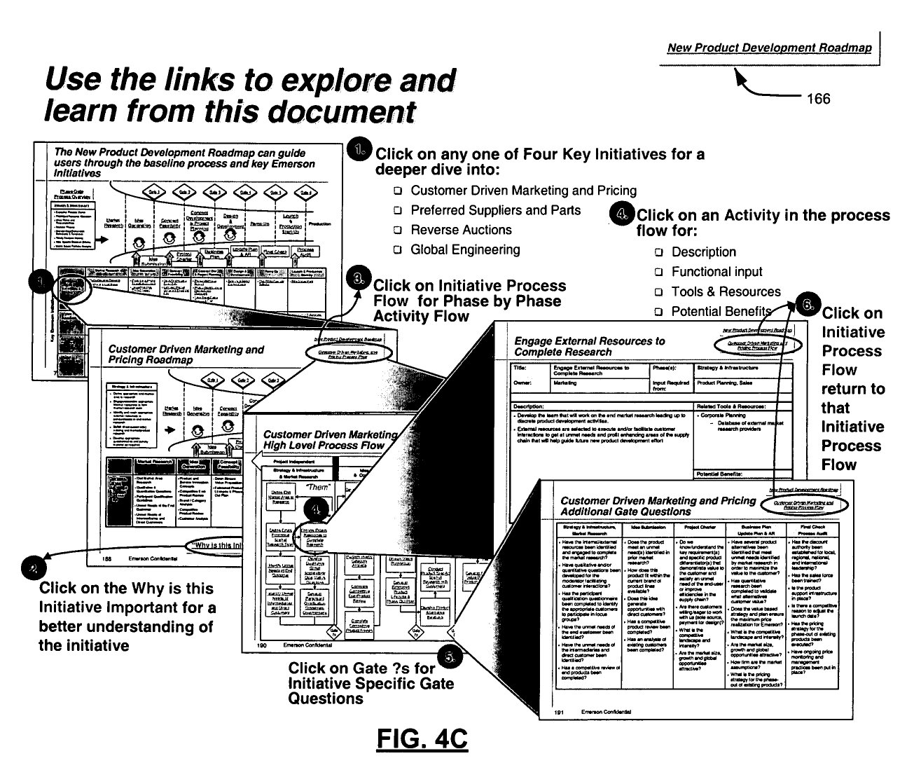

Referring now to FIG. 3, an interactive product development tool 100 defines project phases 104-1, 104-2, . . . , and 104-N (collectively referred to as phases 104) and project gates 106-1, 106-2, . . . , and 106-M collectively referred to as gates 106), which are integrated with key company initiatives 108-1, 108-2, . . . and 108-O (collectively referred to as initiatives 108). In some implementations, the phases are successive phases although some phases can optionally be parallel to another phase. A link 120 such as a hyperlink, page link or page number directs a user to instructions that appear in FIGS. 4A-4C, which will be described further below. Each of the project phases, gates and key initiatives provide links to additional information describing a corresponding phase, gate and/or key initiative as will be described further below.

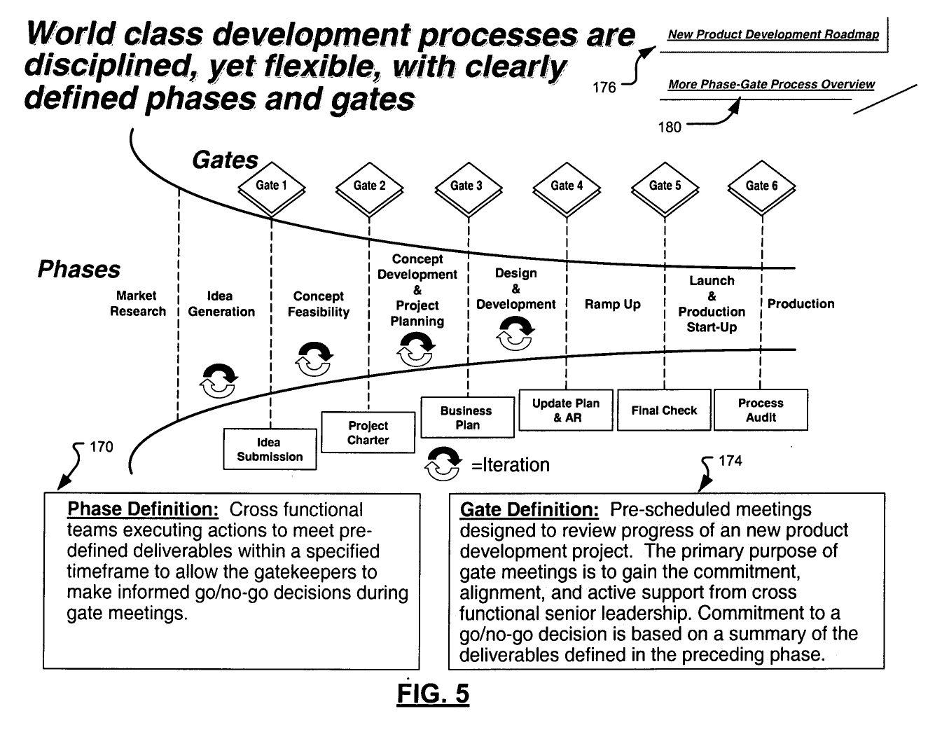

A table 124 identifies a relationship between initiatives 108 and phases 104. For each key initiative 108 and phase 104, additional information is provided via links 128. For example for the market research phase 104-1 and the customer driven marketing and pricing initiative 108-1, additional information relating to end market area research 128-1, qualitative and quantitative questions 128-2, participant qualification guidelines 128-3, unmet needs of end customer 128-4, and unmet needs of intermediaries and direct customers 128-5 is provided. The links 128 provide additional information for assisting management in meeting the key initiative at the particular phase. Similarly, additional links are provided for other phases 104 and key initiatives 108. In addition to the foregoing, additional links to a phase-gate process overview are provided at 140, as will be described below in conjunction with FIG. 5.

Referring now to FIG. 4A, interactive instructions for using the product phases, deliverables, and best practices that are accessible from the product development tool of FIG. 3 are shown. Clicking on link 140 provides additional information relating to benefits of using a phase-gate process, the importance of executive process owner and senior leadership involvement, roles and responsibilities, objectives for each gate, functional representation and levels of gatekeepers, gate specific decision criteria, gate meeting approaches, integration with product lifecycle and product data management tools and critical success factors.

Clicking on one of the phases 104 in FIG. 3 provides a link to additional information relating to the selected phase. Once on the new page relating to the selected phase, additional links are provided that define deliverables by company functional groups. Clicking on a particular deliverable provides a link to additional information including a deliverable definition, functional group input, tools and best practices and considerations. A return link 150 to FIG. 3 and a return link 160 to FIG. 4 may be provided.

Referring now to FIG. 4B, interactive instructions for using the product gates and metrics that are accessible from the product development tool of FIG. 3 are shown. Selecting one of the gates provides a link to additional information defining the particular gate and gate criteria. Once on this selected gate page, additional links are provided to metrics for the particular gate. A return link 162 is provided to FIG. 3 and a forward link 164 to additional information in FIG. 4C are provided.

Referring now to FIG. 4C, interactive instructions for using the key initiatives and initiative process flows that are accessible from the product development tool of FIG. 3 are shown. Clicking on one of the key initiatives 108 in FIG. 3 provides a link to additional information about the selected initiative. When the selected key initiative containing the additional information is reached, additional links are provided to pages explaining why a particular key initiative is important to the company. Additional links are provided to an initiative process flow page that defines additional information relating to initiative process flow for phase-by-phase activity flow. On the initiative process flow page, activities maybe selected and links provided to additional pages defining particular activities.

Referring now to FIG. 5, an interactive description of project phases and gates is provided. Clicking on link 140 in FIG. 3 provides this additional information relating to phases and gates. A phase definition 170 and a gate definition 174 as well as return links 176 to the tool in FIG. 3 and forward links 180 to additional phase gate process overview are provided.

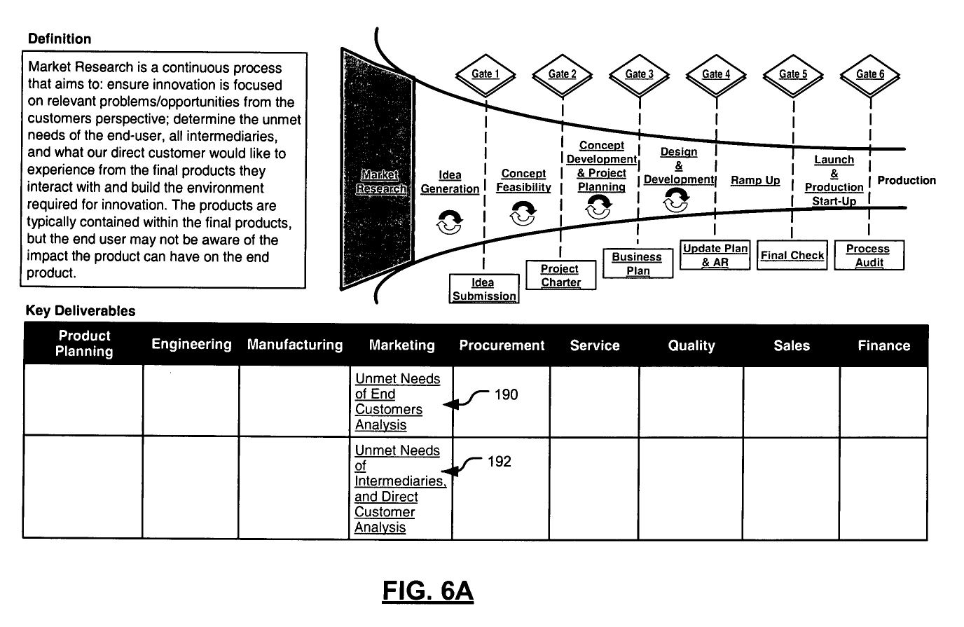

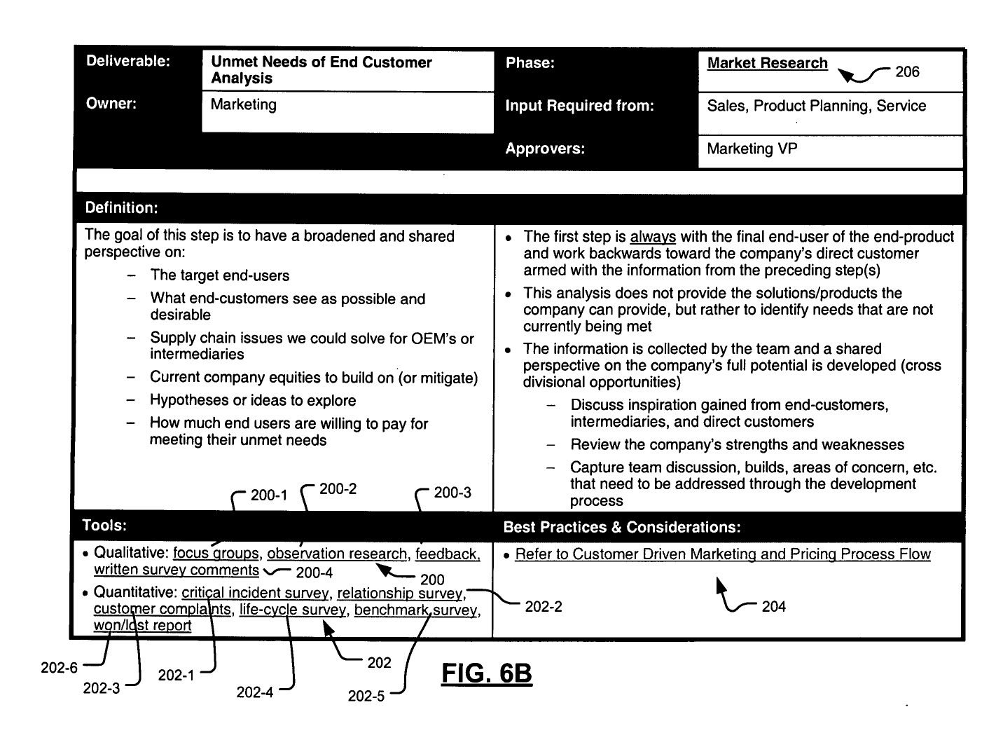

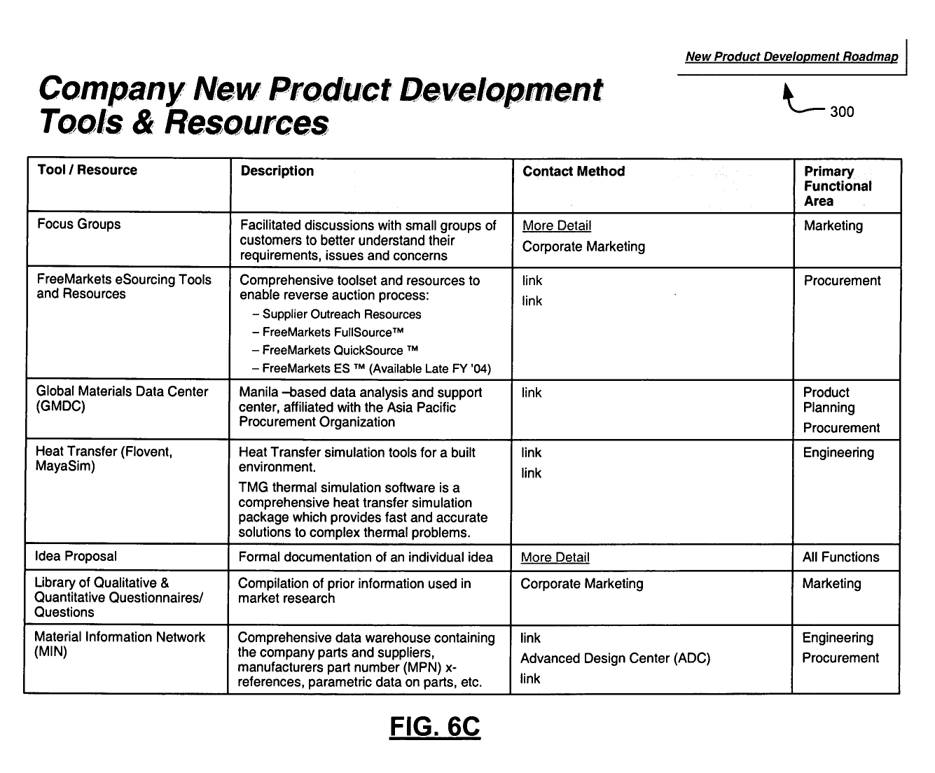

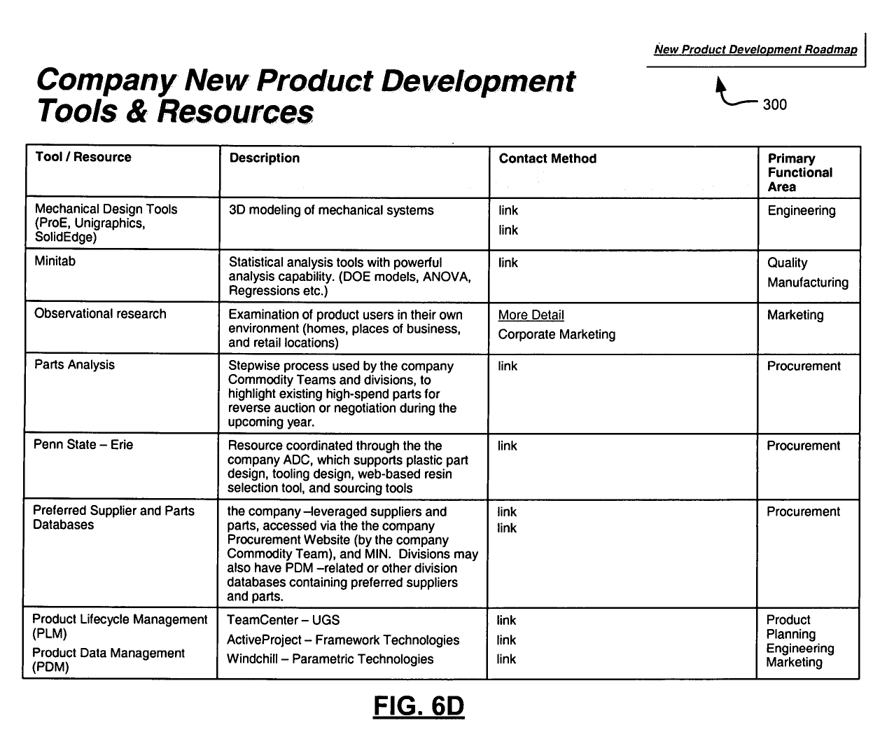

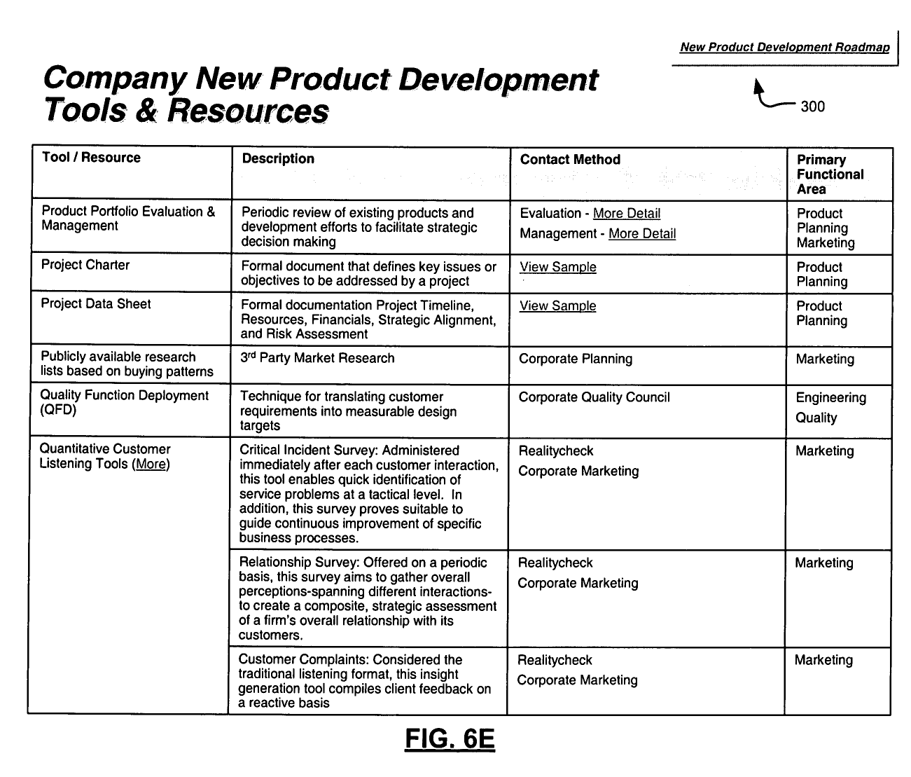

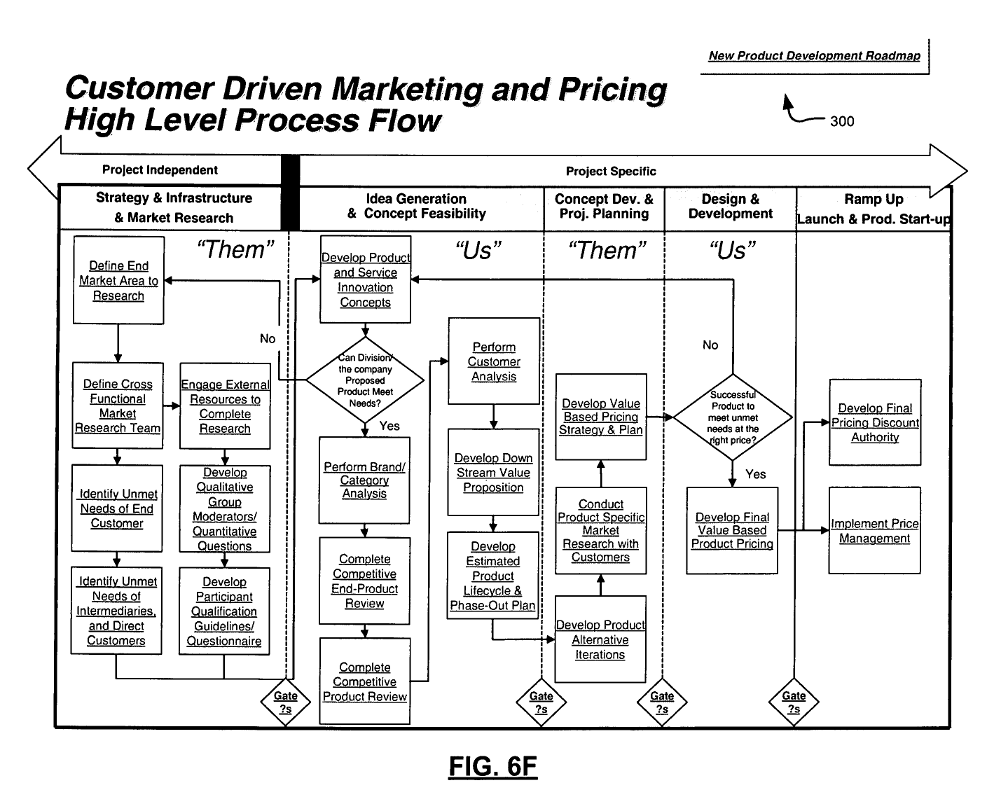

Referring now to FIG. 6A, an interactive description relating to a market research project phase includes key deliverables that are defined by company functional groups. When a user selects the market research phase 104-1 in the tool of FIG. 3, the user is provided additional information relating to key deliverables by company functional groups. During the market research phase, the marketing functional group is the only group having deliverables 190 and 192 in this example. Skilled artisans will appreciate that in any particular phase, one or more of the company functional groups may have deliverables. Selecting one of the deliverables links 190 and 192 provides additional information such as that shown in FIGS. 6A and 6B.

Referring now to FIG. 6B, an interactive description of unmet needs of end customers analysis is provided when the user selects the deliverable link 190 (collectively 200) links 200-1, . . . , and 200-N and 202-1, . . . , and 202-M (collectively 202). Defined information includes the deliverable name, the company functional group that is the owner, the related phase, company functional groups that may be required to provide input, approvers, a deliverable definition, qualitative and tools and links 204 to best practices and considerations. A return link 206 to FIG. 6A may be provided.

The qualitative links 200 and 202 may include links to focus groups 200-1, observation research 200-2, feedback 200-3, and/or written survey comments 200-4, although other qualitative or other types of links may be provided. Quantitative links 206 may include links to critical incident survey 202-1, relationship survey 202-2, customer complaints 202-3, lifecycle survey 202-4, benchmark survey 202-5 and/or won/lost report 202-6, although other quantitive or other types of links may be provided.

In FIG. 6C, an exemplary interactive description for tools and resources relating to qualitative focus groups is shown. This information is provided when a link 200-1 is selected in FIG. 6B, selected from the unmet needs of end customers analysis of FIG. 6B. In FIG. 6D, an exemplary interactive tool and resource relating to qualitative observational research and other items selected from the unmet needs of end customers analysis of FIG. 6B is shown. This information is provided when a link 200-2 is selected in FIG. 6B. In FIG. 6E, an exemplary interactive tool and resource relating to quantitative critical incident survey and other items selected from the unmet needs of end customers analysis of FIG. 6B is shown. This information is provided when a link 202-1 is selected in FIG. 6B. Additional links may be provided to provide additional information. These links may be links within the product development tool or tools, company names, samples, other resources and/or information available on the Internet, an intranet or an extranet.

Referring now to FIG. 6F, a customer driven marketing and pricing high level process flow that is selectable from the unmet needs and customer analysis of FIG. 6B using link 204 and/or from other locations in the tool is shown. Each of the steps in the process can be selected by clicking on a link. The user is directed to a page providing additional information relating to the selected step. The information may include a description of the activity, functional input, tools and resources and potential benefits.

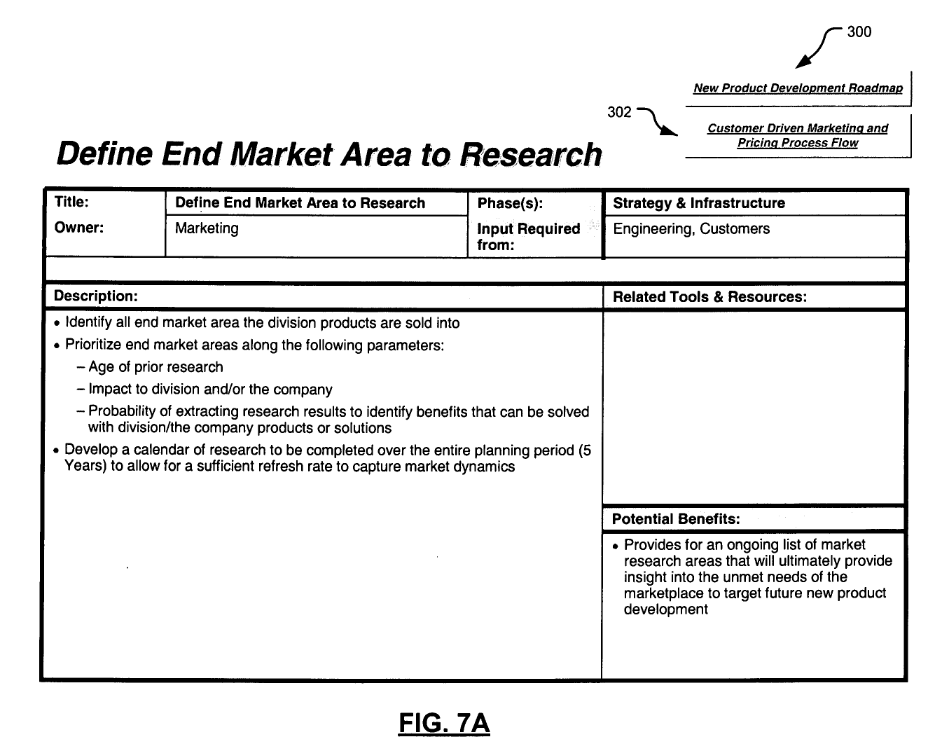

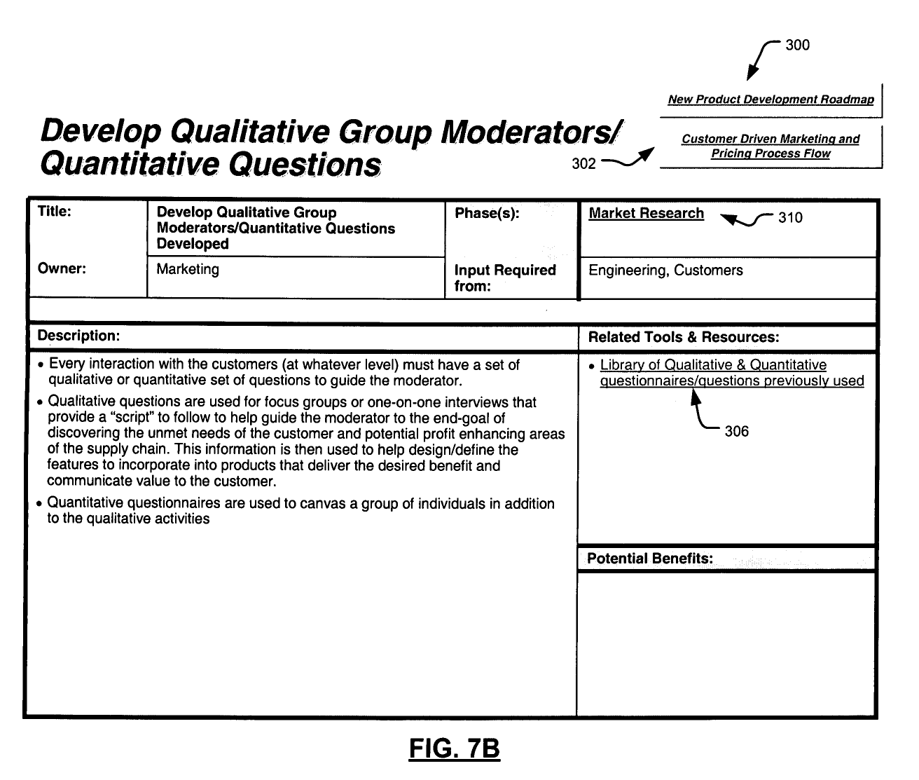

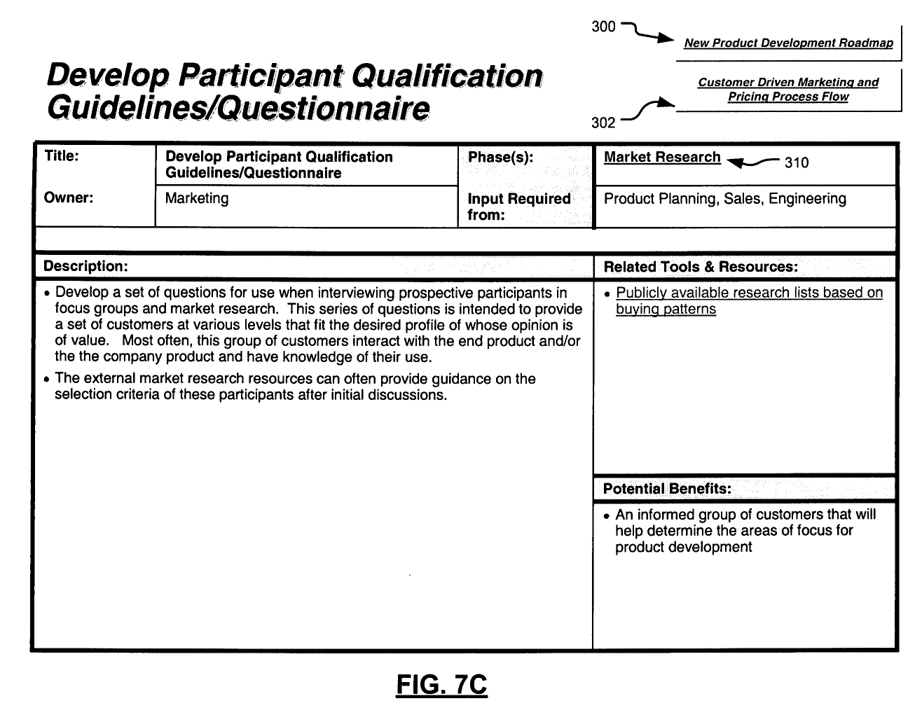

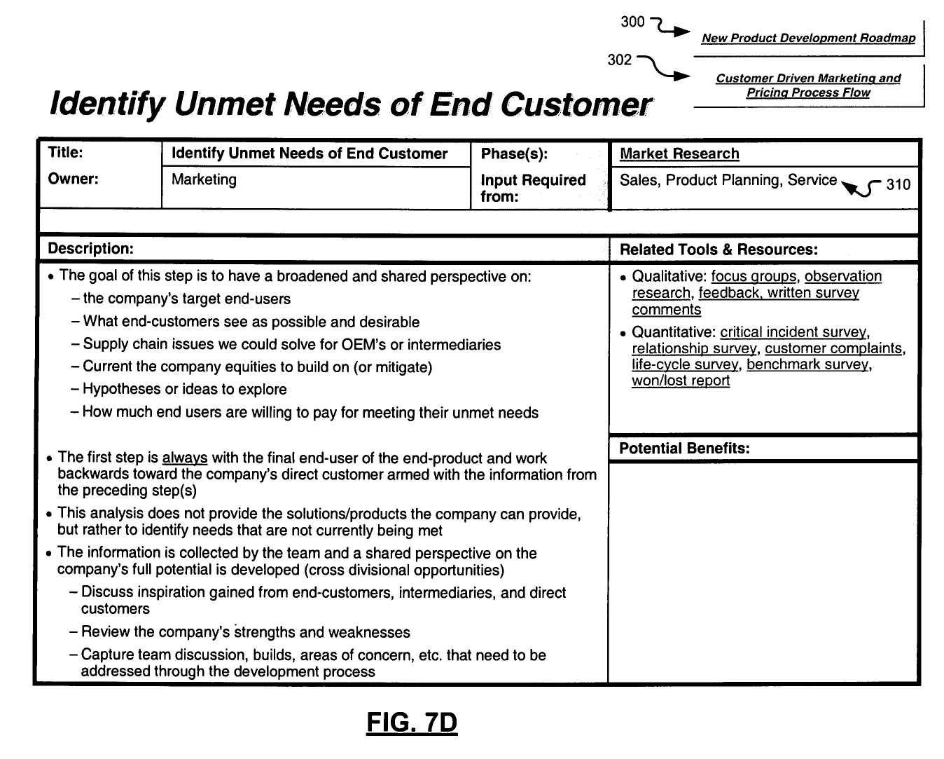

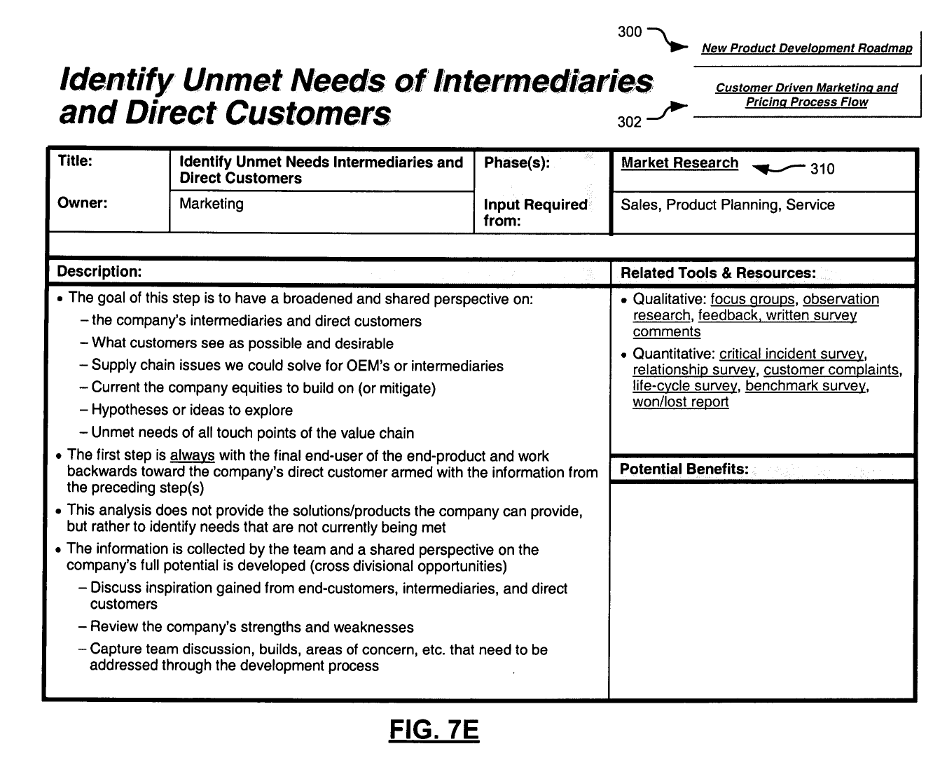

Referring now to FIG. 7A, an interactive description for end market area research is shown. This information is selectable from the customer driven marketing and pricing key initiative in the market research phase of FIG. 3. When the user selects the end market area research link 128-1 in FIG. 3, information shown in FIG. 7A is provided. In this example, the end market area research requires input from engineering and customers. During this phase, the marketing functional group should identify all end market areas within which the division products are sold. The marketing functional group should prioritize end market areas along the following parameters: age of prior research; impact to division and/or the company; probability of extracting research results to identify benefits that can be solved within division/company products or solutions; and develop a calendar of research to be completed over the entire plan to allow for a sufficient refresh rate to capture market dynamics. Potential benefits are also provided to encourage users to participate in this particular phase. In this example, benefits include providing an ongoing list of market research areas that will ultimately provide insight into unmet needs of the marketplace to target future new product development. A return link 300 as well as a link 302 to the process flow of FIG. 6F are provided.

Referring now to FIG. 7B, an interactive description relating to developing qualitative group moderators/quantitative questions is shown. This information is also selectable from the customer driven marketing and pricing key initiative in the market research phase of FIG. 3. When the link 128-2 is selected in FIG. 3, the user is provided additional information shown in FIG. 7B. Input for this initiative is required from the engineering functional group and customers. Interactions with customers should have a set of qualitative or quantitative questions to guide a moderator. The user is encouraged to develop qualitative questions to be used for focus groups or one-on-one interviews. A script will help guide the moderator to the end goal of discovering unmet needs of the customer and potential profit enhancing areas of the supply chain. This information is then used to help design and define features to incorporate into products that deliver the desired benefit and communicate value to the customer. Quantitative questionnaires may be used to canvass a group of individuals in addition to the qualitative activities. Links 306 are provided to a library of qualitative and quantitative questionnaires. A return link 310 to the market research phase 104-1 are provided.

Referring now to FIGS. 7C-7E, additional interactive descriptions relating to the customer driven marketing and pricing key initiative in the market research phase are shown. In FIG. 7C, an interactive description relating to developing participant qualification guidelines/questionnaires are shown. This information is presented when link 128-3 in FIG. 3 is selected. In FIG. 7D, an interactive description relating to identification of unmet needs of end customer is shown. This information is presented when link 128-4 in FIG. 3 is selected. In FIG. 7E, an interactive description relating to identification of unmet needs of intermediaries and direct customers is shown. This information is presented when link 128-5 in FIG. 3 is selected. As can be appreciated, other phases and key initiatives may employ a similar approach. In some phases, only one key initiative may be implicated. In other phases, multiple key initiatives may be implicated. Each of these descriptions may include links to phases, tools, process descriptions, resources, etc.

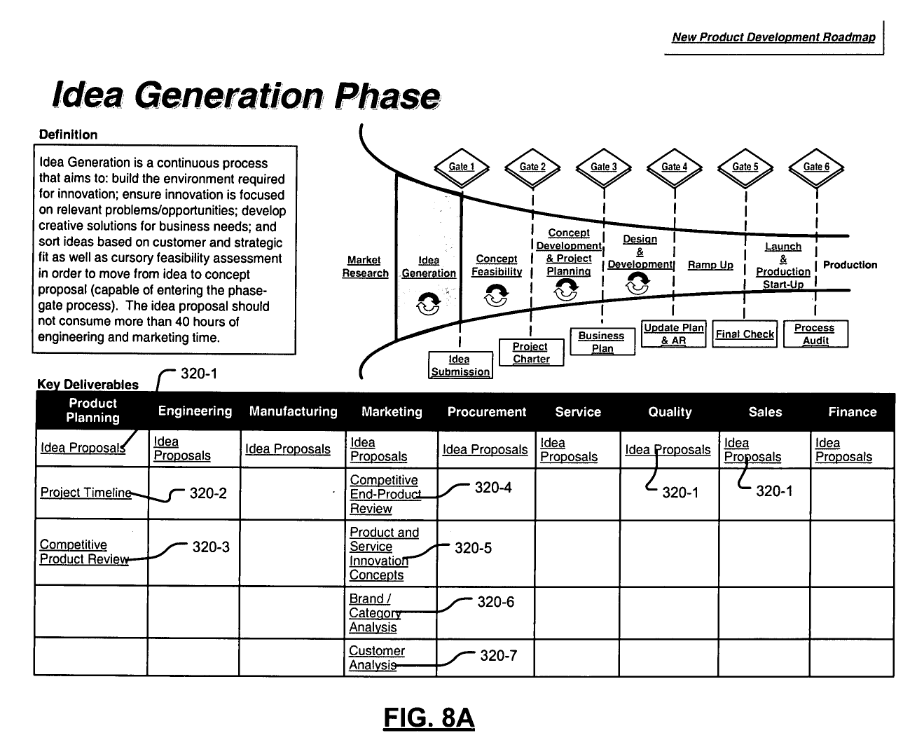

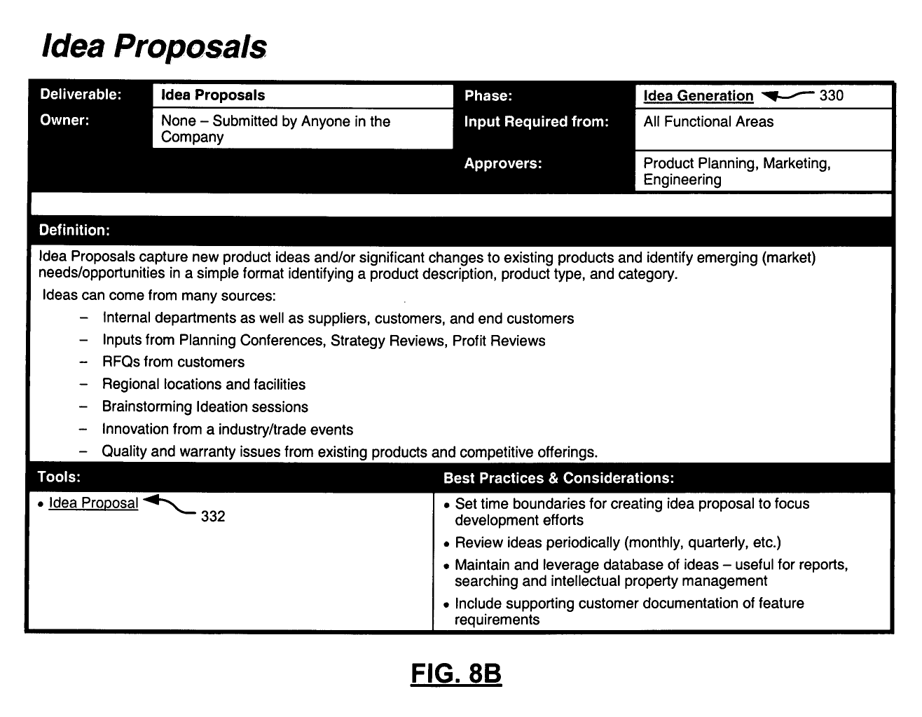

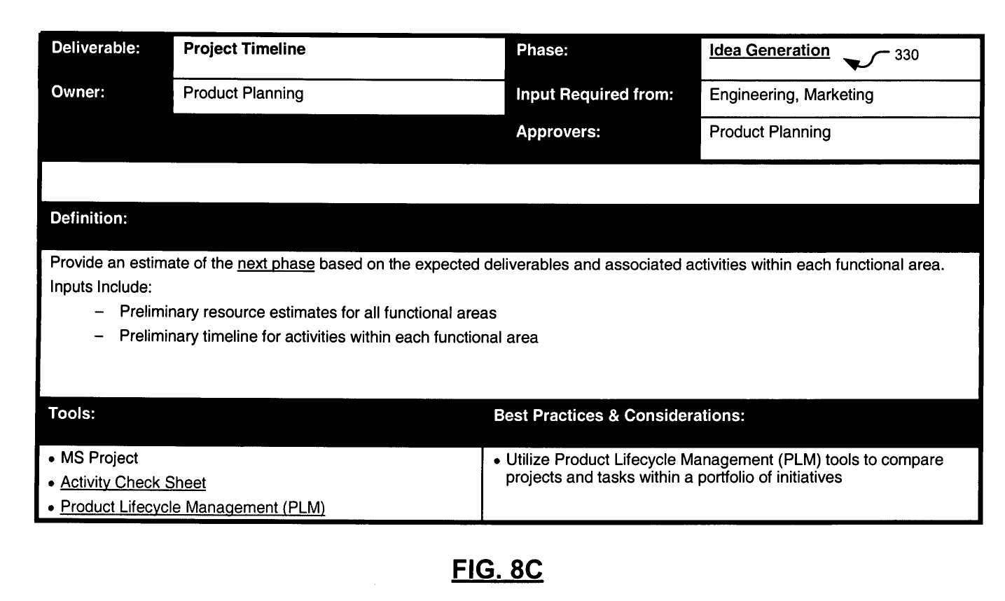

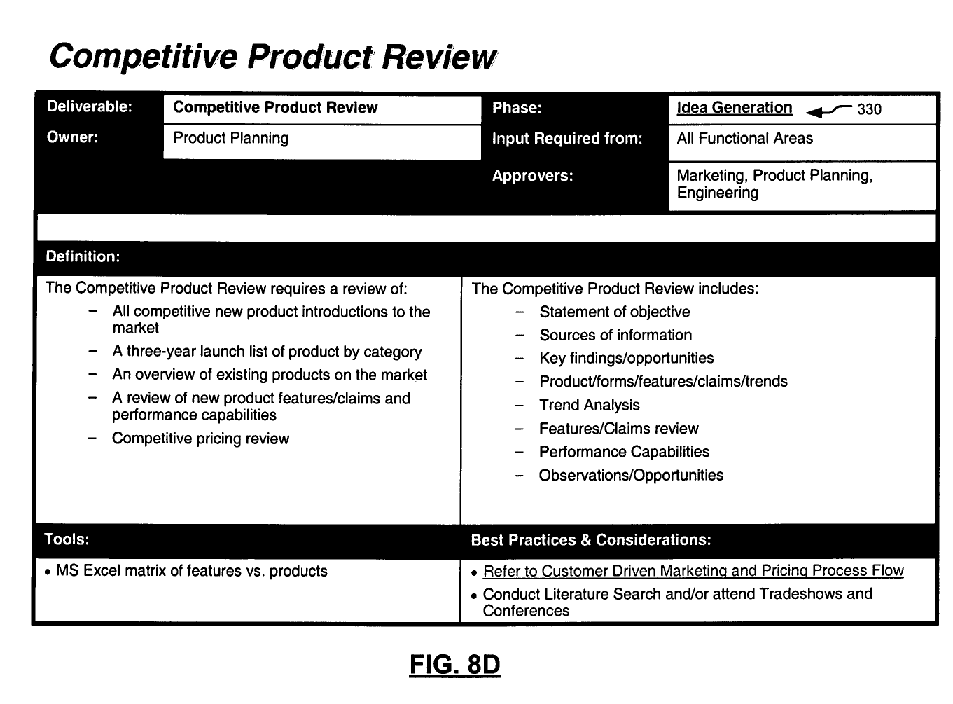

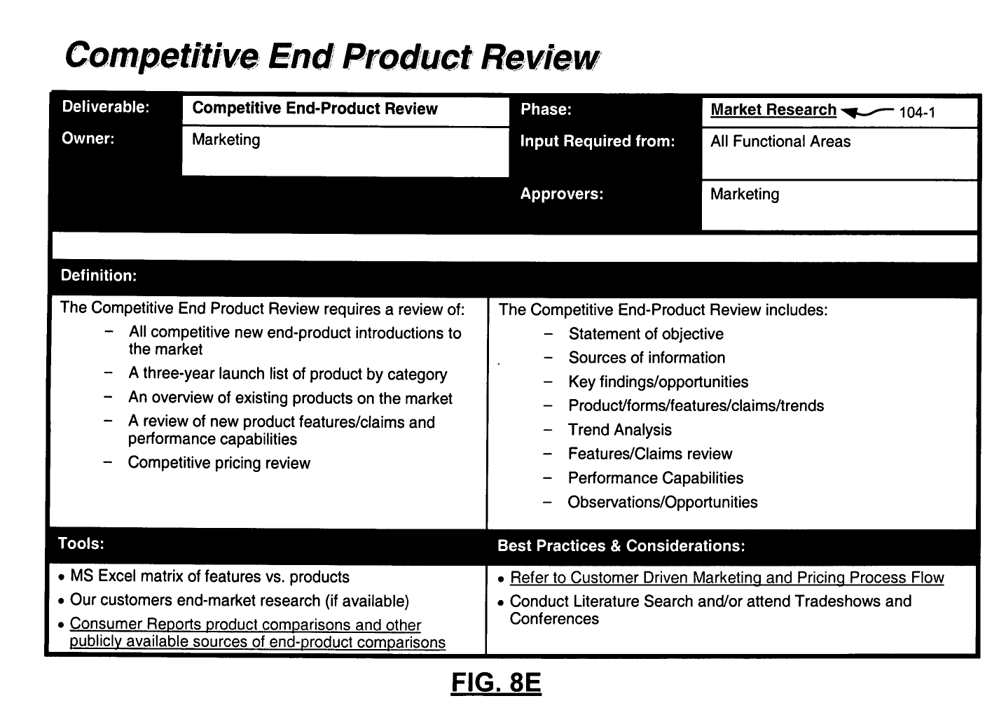

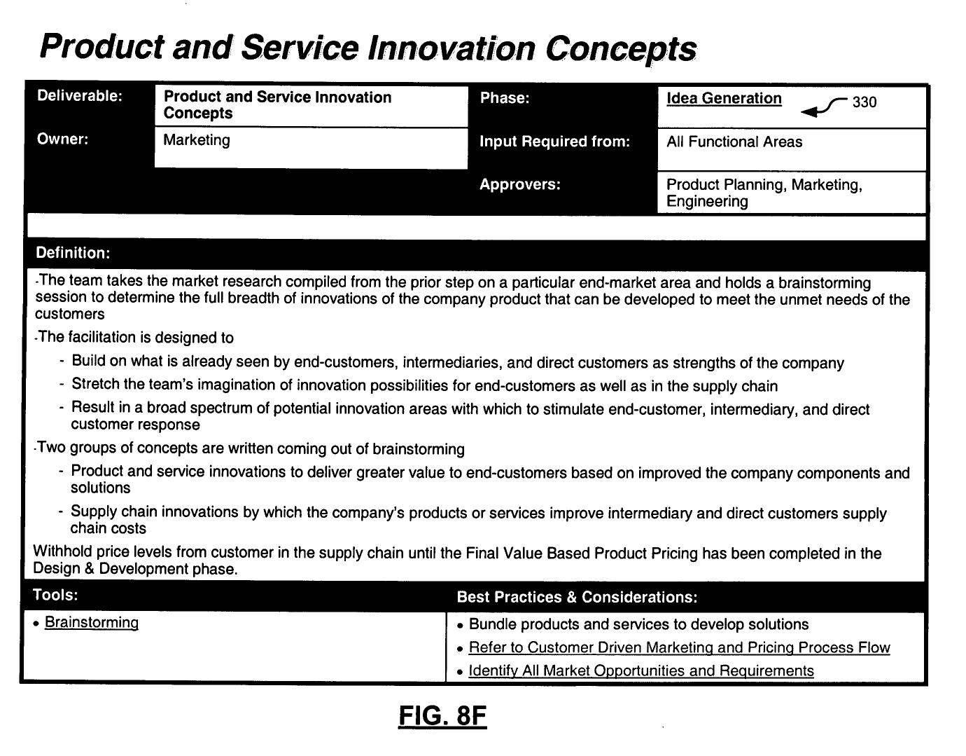

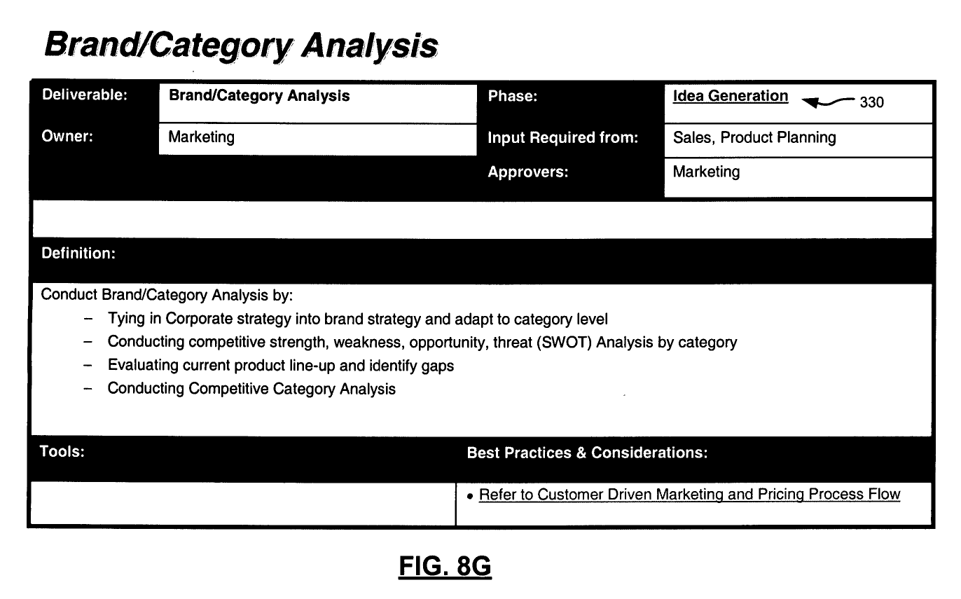

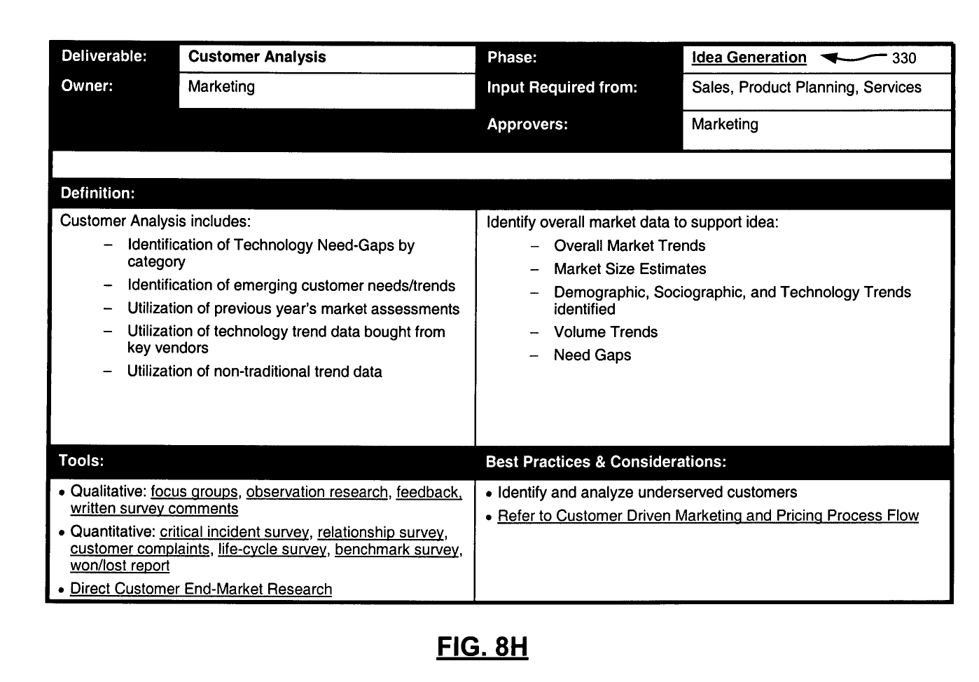

Referring now to FIG. 8A, an interactive description of an idea generation phase is shown that describes key deliverables by corresponding company functional groups. In addition, a definition of the idea generation phase is also provided. Clicking on links (generally identified at 320-1, 320-2, . . . , and 320-7) provided in FIG. 8A directs the user to additional description and/or interactive information.

Referring now to FIG. 8B, an interactive description of idea proposal deliverables description is shown. This deliverable is accessible from multiple company functional groups in FIG. 8A using link 320-1. In other words, idea proposals can be submitted by anyone in the company. Exemplary approvers include product planning, marketing and engineering functional groups. The idea proposals deliverable facilitates capturing new product ideas and/or significant changes to existing products and identifies emerging needs and opportunities in a simple format identifying the product description, product type and category. Ideas can come from many sources including internal departments as well as suppliers, customers and end customers; inputs from planning conferences, strategy reviews and profit reviews; request for quotes from customers; ideas from regional locations and facilities; brainstorming sessions; innovation from industry/trade events; and/or quality and key issues from existing products and competitive offerings. Best practices and considerations that are defined include setting time boundaries for creating idea proposals to focus development efforts; reviewing ideas periodically; maintain leverage and idea database; and supporting customer documentation of the feature requirements. A return link 330 to FIG. 8A and a link 332 to idea proposal tools are provided.

Referring now to FIGS. 8C-8H, other deliverables that are accessible from the idea generation phase description in FIG. 8A are shown. In a manner similar to FIG. 8B, these interactive descriptions define the deliverable, identify owners, approvers and input providers, provide links to tools and define best practices and considerations. In FIG. 8C, an interactive project timeline deliverables description for the product planning functional group is shown and is accessible via link 320-2 in FIG. 8A. In FIG. 8D, an interactive competitive product review deliverable description for the product planning functional group is shown and is accessible via link 320-3 in FIG. 8A. In FIG. 8E, an interactive competitive end product review deliverable description for the marketing functional group is shown and is accessible via link 320-4 in FIG. 8A. In FIG. 8F, an interactive product and service innovation concepts deliverable description for the marketing functional group is shown and is accessible via link 320-5 in FIG. 8A. In FIG. 8G, an interactive brand/category analysis deliverable description for the marketing functional group is shown and is accessible via link 320-5 in FIG. 8A. In FIG. 8H, an interactive customer analysis deliverable description for the marketing functional group is shown and is accessible via link 320-7.

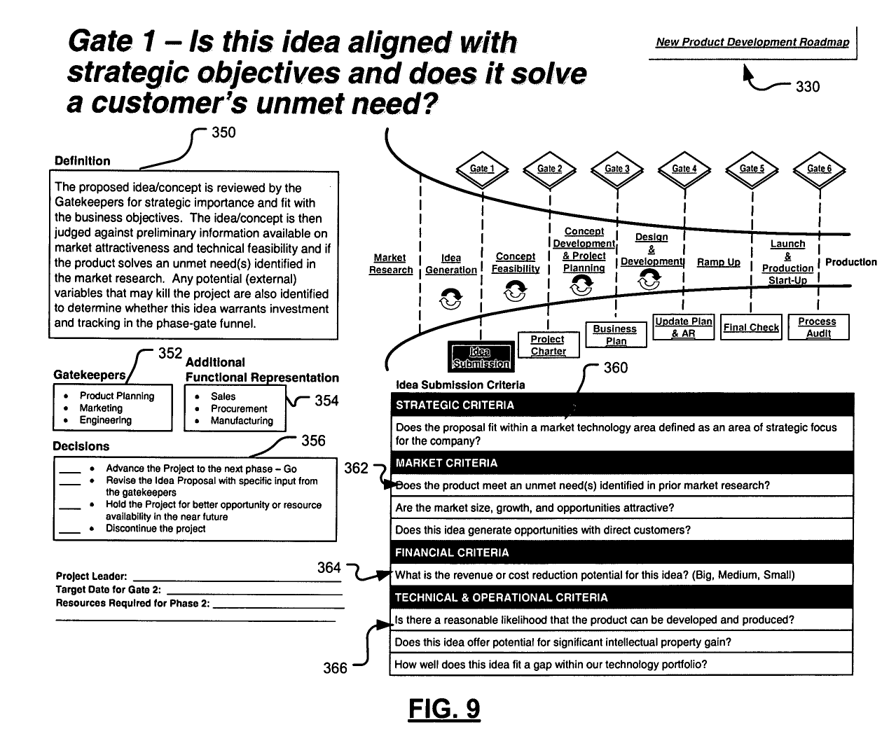

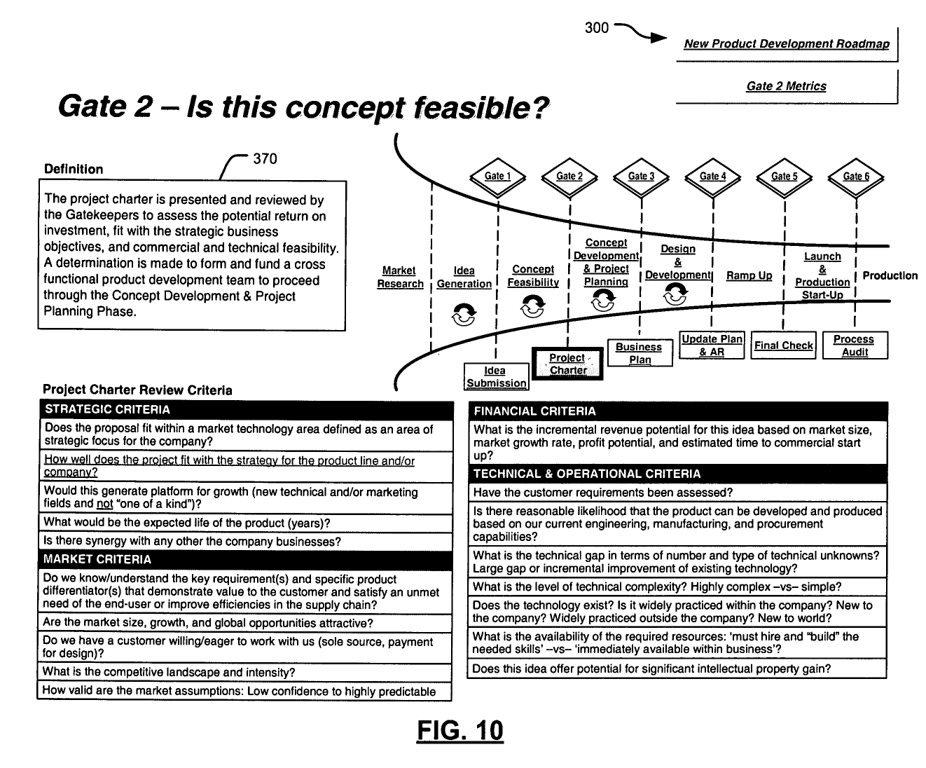

Referring now to FIG. 9, an interactive first project gate description is shown that corresponds to the idea submission project gate 106-1. This description includes a gate definition 350, identifies gatekeepers 352 and additional functional group representation 354, and defines decisions 356 to be completed for advancement to the subsequent concept feasibility phase 104-3. In addition, gate decision criteria such as strategic criteria 360, market criteria 362, financial criteria 364 and technical and operational criteria 366 are defined.

For example, strategic criteria may include a decision as to whether the proposal fits within a market technology area defined as an area of strategic focus for the company. Market criteria may include whether or not the product meets an unmet need identified in prior market research, whether the market size, growth and opportunities are attractive, and/or whether the idea generates opportunities with direct customers. Financial criteria may include a coarse decision as to whether or not the revenue or cost-reduction potential for the idea is small, medium or large. Technical and operational criteria may include a decision as to whether or not there is a reasonable likelihood that the product can be developed and produced, whether the idea offers the potential for significant intellectual property gain, and/or a decision as to how well the idea fits a gap within the company's technology portfolio.

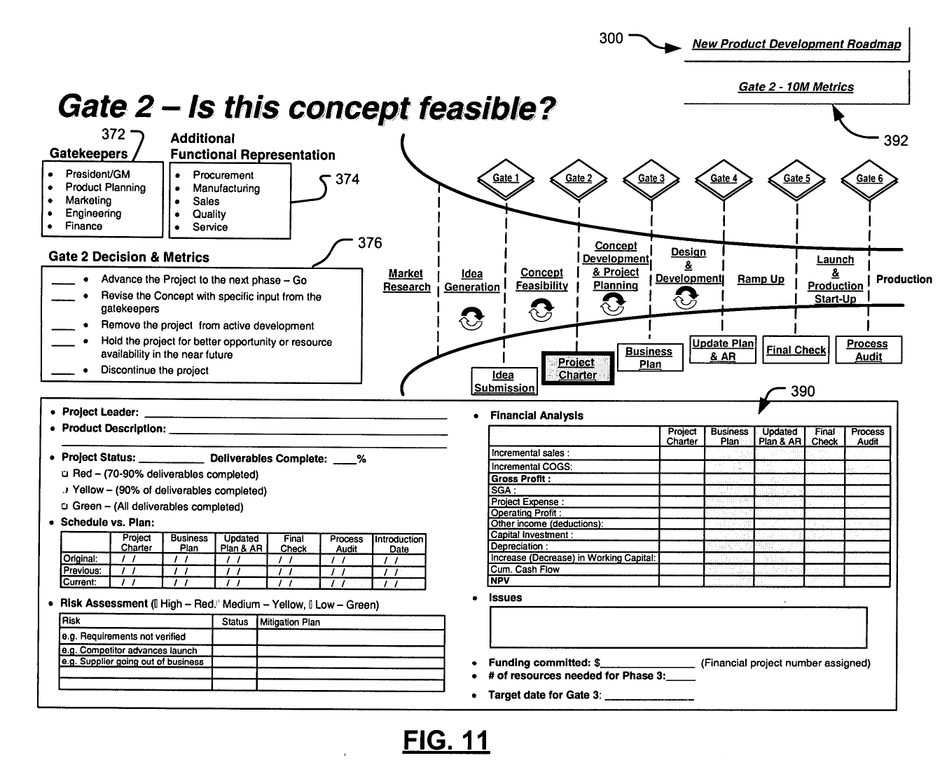

Referring now to FIGS. 10 and 11, an interactive second project gate description is shown. In this example, the second gate corresponds to a project charter gate 106-2. This gate description includes a gate definition 370, identifies gatekeepers 372 and additional functional group representation 374, and defines decisions and metrics 376. In addition, decision criteria such as strategic criteria 380, market criteria 382, financial criteria 384 and technical and operational criteria 386 are defined. Metrics generally shown at 390 in FIG. 11 are defined for the second gate and are accessible via a link 392 in FIG. 10. Exemplary metrics that are associated with the second project gate are shown. As can be appreciated, some gates will not have metrics and others may have one or more sets of metrics.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, the specification and the following claims.

What is claimed is:

1. A system for improving a product development process in a company, comprising:
a computer including a display and a selecting device;
an interactive program that is accessible using said computer, said display and said selecting device, that visually depicts said product development process divided into project phases, project gates between at least two pairs of adjacent project phases and key initiatives of the company to be considered at said project phases.

2. The system of claim 1 wherein said interactive program provides key initiative links to a description of at least one of tasks, tools and resources as a function of said project phases and said key initiatives, wherein said at least one of tasks, tools and resources are designed to facilitate achieving said key initiatives at said project phase.

3. The system of claim 1 wherein said interactive program provides phase links for each of said project phases, wherein said phase links provide descriptions of deliverables by company functional groups for respective ones of said project phases.

4. The system of claim 1 wherein said interactive program provides gate links for each of said project gates, wherein said gate links define gate decisions to be made before proceeding to a subsequent phase.

5. The system of claim 3 wherein said interactive program provides a description specifying a deliverable definition and identifying at least one of said company functional groups to provide input for each of said deliverables.

6. The system of claim 5 wherein said interactive program provides best practices links to information defining best practices for at least one of said deliverables.

7. The system of claim 5 wherein said interactive program provides assistance tool links to assistance tools for at least one of said deliverables.

8. The system of claim 1 wherein said interactive program provides metric links defining project metrics for at least one of said project gates.

9. The system of claim 1 wherein said interactive program includes a browser, hyperlinks and web pages.

10. The system of claim 1 wherein said interactive program includes a presentation program, a presentation file and page links within said presentation file.

11. The system of claim 1 wherein said interactive program provides gate links for each of said project gates and wherein said gate links link a user to a corresponding project gate description that includes a gate definition and at least one set of decision criteria.

12. The system of claim 1 wherein said interactive program provides phase links for each of said project phases and wherein said phase links link a user to a corresponding project phase description that includes a phase definition and a key deliverables table arranged by said functional groups.

13. The system of claim 12 wherein said key deliverables table includes links to at least one deliverable description defining a respective deliverable and additional links to qualitative and quantitative tools and best practices and considerations.

14. A method for developing products for a company, comprising:
dividing a product development process into a plurality of project phases;
specifying a plurality of project gates between at least two pairs of adjacent phases;
for each of said project gates, defining gate decisions to be made before proceeding to a subsequent phase;
defining a plurality of key initiatives of the company; and
for each of said key initiatives, defining at least one of tasks, tools and resources as a function of said project phases that are designed to facilitate achieving said key initiatives.

15. The method of claim 14 for each of said plurality of project phases, defining deliverables by functional groups within the company.

16. The method of claim 15 further comprising, for each of said deliverables, specifying a deliverable definition and identifying at least one of said functional groups to provide input.

17. The method of claim 16 further comprising, for each of said deliverables, defining company-defined best practices.

18. The method of claim 15 further comprising defining assistance tools for each of said deliverables.

19. The method of claim 14 further comprising assigning gatekeepers to make said gate decisions for each of said project gates.

20. The method of claim 19 further comprising defining project metrics for each of said project gates.

21. The method of claim 14 further comprising providing a visual display showing a relationship between said project phases, said project gates, said key initiatives.

22. The method of claim 21 wherein said visual display is interactive.

23. The method of claim 21 wherein said visual display includes links to project phase descriptions for said project phases, project gate descriptions for said project gates, and key initiative descriptions for said key initiatives.

24. The method of claim 23 wherein said visual display includes links to descriptions of said at least one of tasks, tools and resources and wherein said links are arranged by said key initiative and said project phases.

25. The method of claim 21 further comprising implementing said visual display using hyperlinks in a web page.

26. The method of claim 21 further comprising implementing said visual display using links in a presentation program.

27. The method of claim 23 wherein said project gate description includes a gate definition and at least one of set of criteria selected from a group consisting of strategic criteria, market criteria, financial criteria and technical and operational criteria.

28. The method of claim 23 wherein said project phase description includes a phase definition and a key deliverables table arranged by said functional groups.

29. The method of claim 28 wherein said key deliverables table includes links to at least one deliverable description defining a respective deliverable and additional links to qualitative and quantitative tools and best practices and considerations.

30. We claim any patentable subject matter in this disclosure.
